(19) United States
(12) Patent Application Publication
(10) Pub. No.: US 2016/0170355 A1
(43) Pub. Date: Jun. 16, 2016

(54) AUTOMATIC DOCUMENT FEEDER, IMAGE READING DEVICE, IMAGE FORMING APPARATUS, AND IMAGE FORMING SYSTEM

(71) Applicants: Fumiyuki HEISHI, Kanagawa (JP); Takeshi AKAI, Kanagawa (JP); Atsushi KANAYA, Kanagawa (JP); Yoshito SUZUKI, Kanagawa (JP); Hiroshi KUBO, Kanagawa (JP); Shinya KITAOKA, Kanagawa (JP); Norio KIMURA, Kanagawa (JP)

(72) Inventors: Fumiyuki HEISHI, Kanagawa (JP); Takeshi AKAI, Kanagawa (JP); Atsushi KANAYA, Kanagawa (JP); Yoshito SUZUKI, Kanagawa (JP); Hiroshi KUBO, Kanagawa (JP); Shinya KITAOKA, Kanagawa (JP); Norio KIMURA, Kanagawa (JP)

(73) Assignee: Ricoh Company, Limited, Tokyo (JP)

(21) Appl. No.: 14/948,501

(22) Filed: Nov. 23, 2015

(30) Foreign Application Priority Data
Dec. 11, 2014 (JP) 2014-250905

(51) Int. Cl. G03G 15/00

(52) U.S. Cl. CPC G03G 15/5008

(57) ABSTRACT

An automatic document feeder comprises: a first conveyance portion through which documents from a bundle of documents placed on a paper feeding tray are separated from one another and conveyed to a reading position; a second conveyance portion through which a document having been conveyed to the reading position is ejected onto a paper ejection tray; a detector that detects any one mode from a productivity mode and a silent mode; and a controller that controls, when the detector has detected the productivity mode, the first conveyance portion so as to bring a conveyance speed in the first conveyance portion to a first conveyance speed, and, when the detector has detected the silent mode, controls the first conveyance portion so as to bring a conveyance speed in the first conveyance portion to a second conveyance speed that is slower than the first conveyance speed.

### CROSS-REFERENCE TO RELATED APPLICATIONS

The present application claims priority to and incorporates by reference the entire contents of Japanese Patent Application No. 2014-250905 filed in Japan on Dec. 11, 2014.

### BACKGROUND OF THE INVENTION

1. Field of the Invention

The present invention relates to an automatic document feeder, an image reading device, an image forming apparatus, and an image forming system.

2. Description of the Related Art

There has been conventionally known an image forming apparatus configured to generate reduced noise during operation, the image forming apparatus including: an image forming unit that forms an image by an electrophotography process; a reading unit including an automatic document feeding unit (hereinafter simply referred to as an ADF sometimes) that continuously reads documents; and a paper feeding and conveying unit that conveys recording paper to the image forming unit (see, for example, Japanese Patent No. 4366070).

The apparatus disclosed in Japanese Patent No. 4366070 includes: an image forming unit that forms an image; a plurality of recording paper storing units; a plurality of drive units for conveying recording paper from the respective recording paper storing units to the image forming unit; a reading unit that reads an original document; and a switching unit that switches among a plurality of silent modes in order to reduce noise during operation.

The silent modes include, for example, a mode in which recording is performed while the number of sheets going through recording per unit time is reduced compared with that in the normal mode. The device in Japanese Patent No. 4366070 is configured to individually select execution of each of the silent modes by use of the switching unit.

However, one problem of the conventional image forming apparatus is that, when any one of the silent modes is selected, noise reduction during operation results in reduced productivity in printing because the noise reduction during operation is implemented by reduction in number of sheets going through recording per unit time in the main body of the image forming apparatus.

Another problem of the conventional image forming apparatus is that, although noise reduction regarding the main body of the image forming apparatus has been taken into consideration, noise reduction regarding the ADF included in the image forming apparatus has been totally left out of consideration.

For example, in general, an image reading device including an ADF is often configured to satisfy high productivity in reading that allows a margin, as compared with the productivity in printing of the main body of the image forming apparatus. Such high productivity in reading is obtained by conveying documents as speedily as possible with the document conveyance speed rapidly accelerated and decelerated. Such conveyance imparts a physically large kinetic energy, and therefore incurs friction between paper and such components as a roller and warping and stretching of paper. The resultant sound is large, which is increasingly disadvantageous in terms of noise particularly in recent years.

A conventional image forming apparatus is thus configured in consideration of the productivity in printing (copies per minutes: CPM) of the main body of the image forming apparatus, and without particular intention to reduce noise in an automatic document feeding unit. Therefore, a conventional image forming apparatus has the problem that noise during operation cannot be reduced in an image forming apparatus as a whole or a system as a whole.

In addition, noise regulations are being changed in recent years in a direction toward expansion of coverage of the regulations. Such expansion is exemplified by a change from a noise value only of the main body of the image forming apparatus to a noise value of the combination of the main body of the image forming apparatus and the automatic document feeding unit, that is, a noise value of the entire image forming apparatus.

In view of the above-described problems, there is a need to provide an automatic document feeder, an image reading device, an image forming apparatus, and an image forming system that enable users to select either a productivity mode or a silent mode, and that can reduce noise during operation in the silent mode without reducing productivity in printing.

### SUMMARY OF THE INVENTION

It is an object of the present invention to at least partially solve the problems in the conventional technology.

According to exemplary embodiments of the present invention, there is provided an automatic document feeder comprising: a first conveyance portion through which documents from a bundle of documents placed on a paper feeding tray are separated from one another and conveyed to a reading position; a second conveyance portion through which a document having been conveyed to the reading position is ejected onto a paper ejection tray; a detector that detects any one mode from a productivity mode and a silent mode; and a controller that controls, when the detector has detected the productivity mode, the first conveyance portion so as to bring a conveyance speed in the first conveyance portion to a first conveyance speed, and, when the detector has detected the silent mode, controls the first conveyance portion so as to bring a conveyance speed in the first conveyance portion to a second conveyance speed that is slower than the first conveyance speed.

Exemplary embodiments of the present invention also provide an image reading device comprising the above-described automatic document feeder.

Exemplary embodiments of the present invention also provide an image forming apparatus comprising: the above-described automatic document feeder; and an apparatus main body having a copy function, wherein the detector acquires, from a main body controller of the apparatus main body, information on whether the automatic document feeder is in the productivity mode or in the silent mode.

Exemplary embodiments of the present invention also provide an image forming apparatus comprising: the above-described automatic document feeder; and an apparatus main body having a copy function, wherein the automatic document feeder comprises a receiving unit that receives model information on the apparatus main body, and the controller controls at least one of the first conveyance speed and the second conveyance speed so as to bring the at least one of the first conveyance speed and the second conveyance speed to a conveyance speed or conveyance speeds previously set in accordance with the model information received by the receiving unit.

Exemplary embodiments of the present invention also provide an image forming system comprising: the above-described image forming apparatus; and a finisher that performs a post-process on recording paper on which image fixing has been completed.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a front cross-sectional view illustrating a schematic structure of an image forming apparatus according to an embodiment of the present invention;

FIG. 2 is a schematic structural diagram of an image forming unit in the image forming apparatus according to the embodiment of the present invention;

FIG. 3 is a schematic structural diagram of process units in the image forming unit in the image forming apparatus according to the embodiment of the present invention;

FIG. 4 is a perspective view of hinge coupling units between an apparatus main body and an automatic document feeding unit, in the image forming apparatus according to the embodiment of the present invention;

FIG. 5 is a schematic structural diagram of the automatic document feeding unit in the image forming apparatus according to the embodiment of the present invention;

FIG. 6 is a block diagram illustrating a control structure of the image forming apparatus according to the embodiment of the present invention;

FIG. 7 is a block diagram of a second surface reading unit in the image forming apparatus according to the embodiment of the present invention;

FIG. 8 is a view illustrating one aspect of display of a touch panel in an operation unit in the image forming apparatus according to the embodiment of the present invention;

FIG. 9 represents paper feeding speeds determined for respective modes, which are a productivity mode and a silent mode in the image forming apparatus according to the embodiment of the present invention, for each main body model;

FIGS. 10A and 10B are exemplary line charts each depicting the conveyance speed of document sheets in the automatic document feeding unit in the image forming apparatus according to the embodiment of the present invention, with FIG. 10A representing a line chart of the conveyance speed in a productivity mode and FIG. 10B representing a line chart of the conveyance speed in a silent mode;

FIG. 11 is a graph depicting the relation between the conveyance speed of document sheets and noise in the automatic document feeding unit in the image forming apparatus according to the embodiment of the present invention;

FIGS. 12A and 12B are other exemplary line charts each depicting the conveyance speed of document sheets in the automatic document feeding unit in the image forming apparatus according to the embodiment of the present invention, with FIG. 12A representing a line chart of the conveyance speed in a productivity mode and FIG. 12B representing a line chart of the conveyance speed in a silent mode;

FIG. 13 is a flowchart of setting of the conveyance speed of document sheets that a controller unit in the image forming apparatus according to the embodiment of the present invention executes; and

FIG. 14 is a flowchart illustrating another example of the setting of the conveyance speed of document sheets that the controller unit in the image forming apparatus according to the embodiment of the present invention executes.

### DETAILED DESCRIPTION OF THE PREFERRED EMBODIMENTS

The following describes an embodiment of the present invention with reference to the drawings.

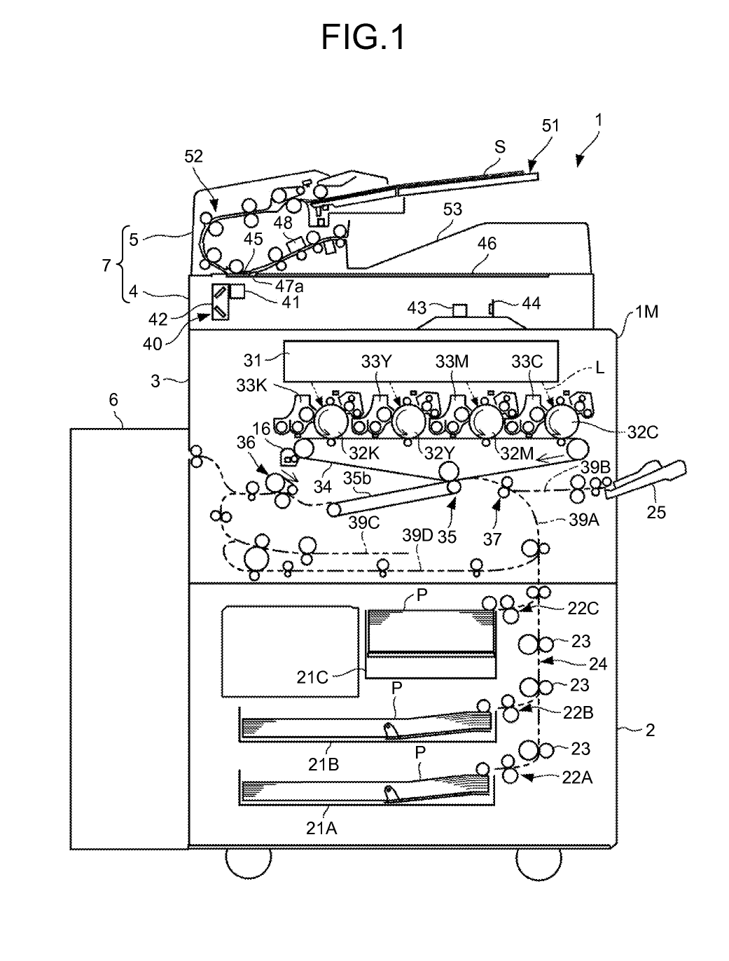

As illustrated in FIG. 1, the image forming apparatus 1 according to the present embodiment is a digital multifunction peripheral including: an apparatus main body 1M including a paper feeding unit 2, an image forming unit 3, and an image reading unit 4; and an automatic document feeding unit (ADF) 5 arranged on the apparatus main body 1M. The image reading unit 4 and the automatic document feeding unit 5 constitute an image reading device 7. An image forming system includes the image forming apparatus 1 and a finisher 6.

The paper feeding unit 2 includes paper feeding cassettes 21A, 21B, and 21C in a plurality of stages, each of which can store stacked sheets of recording paper P formed as cut sheets. In each of the paper feeding cassettes 21A, 21B, and 21C, recording paper P (for example, white paper) of a sheet size previously selected from a plurality of sheet sizes is accommodated in a portrait or landscape orientation in accordance with the paper feeding direction.

The paper feeding unit 2 includes paper feeding devices 22A, 22B, and 22C that sequentially separate and feed individual sheets of recording paper P stored in the paper feeding cassettes 21A, 21B, and 21C, respectively, from the uppermost side. The paper feeding unit 2 further includes various rollers 23 and the like, which form a paper feeding route 24 through which recording paper P fed from each of the paper feeding devices 22A, 22B, and 22C is conveyed to a predetermined image formation position in the image forming unit 3.

The image forming unit 3 includes an exposure device 31, photoconductor drums 32K, 32Y, 32M, and 32C, and developing devices 33K, 33Y, 33M, and 33C filled with black (K), yellow (Y), magenta (M), and cyan (C) toners, respectively. The image forming unit 3 also includes a primary transfer unit 34, a secondary transfer unit 35, and a fixing unit 36.

The exposure device 31 generates, for example, laser beams L for exposure for the respective colors on the basis of an image read by the image reading device 7. The exposure device 31 forms electrostatic latent images for the respective colors on surface layers of the photoconductor drums 32K, 32Y, 32M, and 32C for the respective colors by exposing the photoconductor drums 32K, 32Y, 32M, and 32C to the laser beams. The electrostatic latent images correspond to the read image.

The developing devices 33K, 33Y, 33M, and 33C supply thin-layered toners to the respective photoconductor drums 32K, 32Y, 32M, and 32C in such a manner as to bring the thin-layered toners close thereto, thereby developing the electrostatic latent images into visible images with the toners.

The image forming unit 3 primarily transfers, onto the primary transfer unit 34, the toner images developed on the photoconductor drums 32K, 32Y, 32M, and 32C. A secondary transfer unit 35 located close to the primary transfer unit 34 then secondarily transfers the primarily transferred toner images onto recording paper P. In addition, the image forming unit 3 uses the fixing unit 36 to apply heat and pressure to and melt the toner images secondarily transferred onto recording paper P, thereby fixing and recording a color image on the recording paper P.

The image forming unit 3 includes a conveyance route 39A that transfers recording paper P toward the secondary transfer unit 35 after the recording paper P is conveyed through the paper feeding route 24 from the paper feeding unit 2. In this conveyance route 39A, conveyance timing and conveyance speed of the recording paper P are adjusted by a pair of registration rollers 37 in the first place. Thereafter, the recording paper P passes through the secondary transfer unit 35 and the fixing unit 36 in synchronization with respective belt speeds in the primary transfer unit 34 and the secondary transfer unit 35, and then fed into the finisher 6.

The image forming unit 3 additionally includes a manual feed paper feeding route 39B, through which recording paper (not illustrated) placed on a manual feed tray 25 is fed into the conveyance route 39A at a position upstream of the pair of registration rollers 37.

A switchback conveying path 39C and a reversing conveying path 39D, each of which is constructed of a plurality of conveyance rollers, a conveyance guide, and the like, are disposed below the secondary transfer unit 35 and the fixing unit 36.

When images are to be formed on both sides of a sheet of recording paper P, the switchback conveying path 39C performs switchback conveying in which a sheet of recording paper P having an image already fixed on any one side thereof is caused to enter from one end thereof and then retreat (move in a direction the reverse of that in which it has entered).

The reversing conveying path 39D turns upside down a sheet of recording paper P on which the switchback conveyance has been performed by the switchback conveying path 39C, and feeds the sheet again to the pair of registration rollers 37.

A sheet of recording paper P on one side of which an image fixing process has been completed is caused to move in the reverse direction and turned upside down by these switchback conveying path 39C and reversing conveying path 39D, and then again enters into a secondary transfer nip. The sheet of recording paper P is fed into the finisher 6 after a secondary transfer process and the fixing process are performed on the other side thereof.

The image reading unit 4 includes: a first carriage 41 equipped with a light source (not illustrated) and a mirror member (not illustrated); a second carriage 42 equipped with another mirror member (not illustrated); an imaging forming lens 43; an imaging unit 44; and a first contact glass 45. These components are disposed in the apparatus main body 1M, and constitute a first surface reading unit 40 that performs image reading on an image surface on one side (for example, an image surface on the front side) of a document sheet S conveyed onto the first contact glass 45. Here, a first surface means one surface of a document sheet S that is automatically conveyed, which is an image surface on the front side thereof, for example.

The image reading unit 4 also includes components such as: a second contact glass 46 on which a document sheet S is placed; and a bump member 47a which can be bumped by and thereby position one side of a document sheet S.

The first carriage 41 is provided below the first contact glass 45 and the second contact glass 46 so as to be movable and positionally controllable in rightward and leftward directions in FIG. 1, and allows illuminating light from the light source to be reflected by the mirror member toward an exposure surface to irradiate the exposure surface. Reflected light reflected by a document sheet S is formed into an image by the imaging forming lens 43 after being reflected by respective mirror members that the first carriage 41 and the second carriage 42 are equipped with, and the thus formed image is read by the imaging unit 44.

The image reading unit 4 is capable of performing, with the light source being lit on, exposure scanning on an image surface of a document sheet S placed on the second contact glass 46 while moving the first carriage 41 and the second carriage 42 at speeds the ratio of which is 2:1. The image reading unit 4 is capable of then fulfilling a stationary document reading function (what is called the flatbed scanner function) by reading an image of the document sheet S by way of the imaging unit 44 during this exposure scanning.

The image reading unit 4 is capable of stopping the first carriage 41 at a fixed position immediately under the first contact glass 45. The image reading unit 4 is also capable of then fulfilling a moving document reading function (what is called the ADF scanner function) by which it reads an image on a first surface of a document sheet S without moving an optical system constructed of the light source, the reflection mirrors, and the like while the document sheet S is being automatically conveyed.

The image forming apparatus 1 also includes a second surface reading unit 48 in addition to the first surface reading unit 40 in the image reading unit 4. The second surface reading unit 48 is embedded in the automatic document feeding unit 5. The second surface reading unit 48 scans a second surface of the document sheet S after it has passed above the first contact glass 45. The second surface is an image surface on the back side, for example.

The automatic document feeding unit 5 is joined to the upper part of the apparatus main body 1M of the image forming apparatus 1 by a hinge mechanism so as to be openable and closable. The automatic document feeding unit 5 is operated to swing between an opened position at which the first contact glass 45 and the second contact glass 46 in the image reading unit 4 are exposed, and a closed position at which the first contact glass 45 and the second contact glass 46 are covered.

The automatic document feeding unit 5 is constructed as a sheet-through automatic document feeder. The automatic document feeding unit 5 includes: a document table 51 provided as a table on which to place documents; a document conveying unit 52 composed of various rollers, a guide member, and the like; and a document paper ejection tray 53 on which to accumulate document sheets S after image reading.

The finisher 6 is provided on a lateral side of the apparatus main body 1M, and receives recording paper P, on which image fixing has been completed, that are fed from the fixing unit 36 of the image forming unit 3. The finisher 6 is built as, for example, a stapler that staples a bundle of recording paper P together, a puncher that punches recording paper P, or a paper collator that collates recording paper P, and performs a post-process on recording paper P fed from the image forming unit 3.

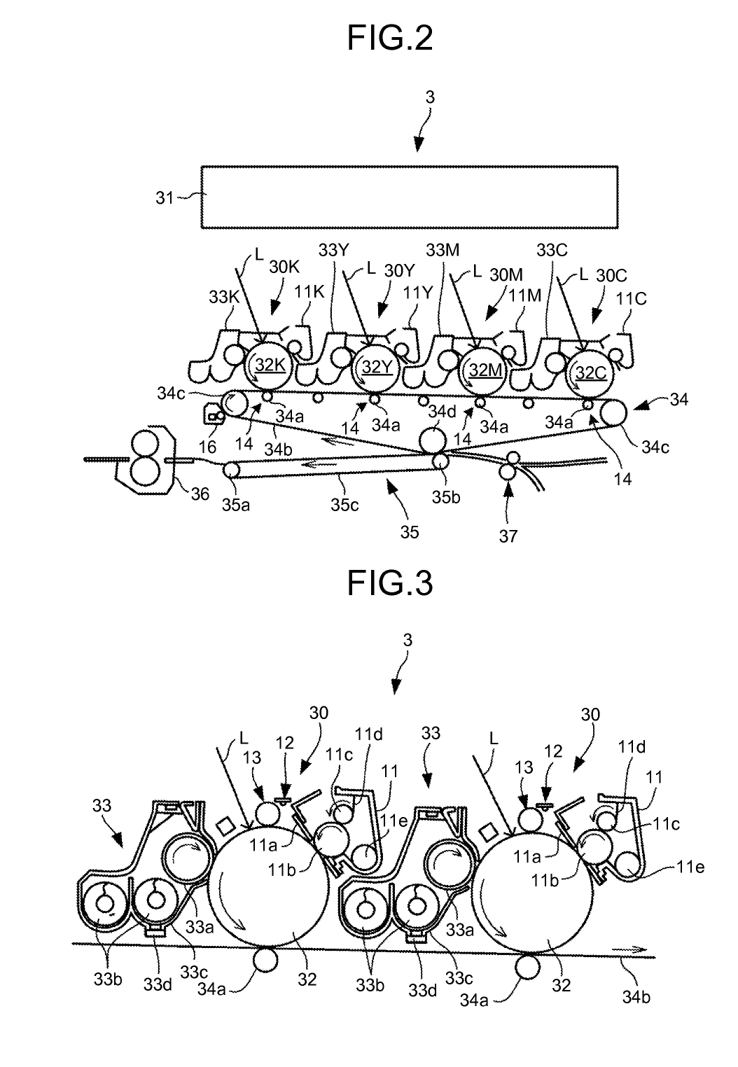

As illustrated in FIG. 2, the image forming unit 3 includes the exposure device 31, the photoconductor drums 32K, 32Y, 32M, and 32C, and the developing devices 33K, 33Y, 33M, and 33C filled with black (K), yellow (Y), magenta (M), and cyan (C) toners, respectively. The image forming unit 3 also includes the primary transfer unit 34, the secondary transfer unit 35, and the fixing unit 36.

In combination with drum cleaning devices 11K, 11Y, 11M, and 11C and the like, the photoconductor drums 32K, 32Y, 32M, and 32C and the developing devices 33K, 33Y, 33M, and 33C constitute process units 30K, 30Y, 30M, and 30C, respectively. These process units 30K, 30Y, 30M, and 30C have structures that are substantially the same except that the colors of toners used in the respective units are different.

The exposure device 31 generates, for example, laser beams L for exposure for the respective colors on the basis of an image read by the image reading device 7. The exposure device 31 forms electrostatic latent images for the respective colors on surface layers of the photoconductor drums 32K, 32Y, 32M, and 32C for the respective colors by exposing the photoconductor drums 32K, 32Y, 32M, and 32C to light. The electrostatic latent images correspond to the read image.

The developing devices 33K, 33Y, 33M, and 33C supply thin-layered toners to the respective photoconductor drums 32K, 32Y, 32M, and 32C, thereby developing the electrostatic latent images into visible images with the toners.

The image forming unit 3 primarily transfers, onto the primary transfer unit 34, the toner images developed on the photoconductor drums 32K, 32Y, 32M, and 32C. A secondary transfer unit 35 located close to the primary transfer unit 34 then secondarily transfers the primarily transferred toner images onto recording paper P. In addition, the image forming unit 3 uses the fixing unit 36 to apply heat and pressure to and melt the toner images secondarily transferred onto recording paper P, thereby fixing and recording a color image on the recording paper P.

The primary transfer unit 34 includes respective transfer units 14 under the photoconductor drums 32 of the four process units 30K, 30Y, 30M, and 30C.

The respective transfer units 14 causes an endless intermediate transfer belt 34b to move in an orbit clockwise in FIG. 2 while making contact with the photoconductor drums 32K, 32Y, 32M, and 32C. The intermediate transfer belt 34b is tightly slung around conveyance rollers 34c and 34d and primary transfer rollers 34a. Thus, a primary transfer nip for each color is formed where a corresponding one of the respective photoconductor drums 32K, 32Y, 32M, and 32C and the intermediate transfer belt 34b makes contact with each other.

In the vicinities of the respective primary transfer nips, primary transfer rollers 34a for the respective colors disposed inside the loop of the intermediate transfer belt 34b press the intermediate transfer belt 34b toward the respective photoconductor drums 32K, 32Y, 32M, and 32C. Primary transfer biases are applied to these primary transfer rollers 34a for the respective colors by respective power supplies (not illustrated). Thus, in the primary transfer nip for each color, a primary transfer electrical field is formed that electrostatically moves a toner image on a corresponding one of the respective photoconductor drums 32K, 32Y, 32M, and 32C toward the intermediate transfer belt 34b.

On the outer circumferential surface (hereinafter, referred to as the outside surface) of the intermediate transfer belt 34b that sequentially passes through the primary transfer nips for the respective colors while moving in an orbit clockwise in FIG. 2, toner images are sequentially overlaid at the respective primary transfer nips. Primary transfer is thus carried out. As a result of this primary transfer by the overlaying, a toner image having four colors overlaid thereon (hereinafter, referred to as a four-color toner image) is formed on the outside surface of the intermediate transfer belt 34b.

The secondary transfer unit 35 is constructed of a drive roller 35a, a secondary transfer roller 35b located close to the conveyance roller 34d of the primary transfer unit 34, and an endless paper conveying belt 35c slung around the drive roller 35a and the secondary transfer roller 35b. The paper conveying belt 35c moves in an orbit in response to rotation of the drive roller 35a.

The intermediate transfer belt 34b of the primary transfer unit 34 and the paper conveying belt 35c of the secondary transfer unit 35 are sandwiched between the conveyance roller 34d of the primary transfer unit 34 and the secondary transfer roller 35b of the secondary transfer unit 35 to the extent that these belts 34b and 35c make contact with each other between the two rollers 34d and 35b. Thus, a secondary transfer nip is formed where the outside surface of the intermediate transfer belt 34b and the outside surface of the paper conveying belt 35c make contact with each other.

A secondary transfer bias is applied to the secondary transfer roller 35b by a power supply (not illustrated). In addition, the conveyance roller 34d in the lower part of the primary transfer unit 34 is earthed. Thus, a secondary transfer electrical field is formed at the secondary transfer nip.

Furthermore, recording paper P is fed out into this secondary transfer nip by the pair of registration rollers 37 at the same speed as a speed at which the intermediate transfer belt 34b moves around and at the moment that allows the recording paper P to synchronize with a four-color toner image on the intermediate transfer belt 34b.

In the secondary transfer nip, a four-color toner image on the intermediate transfer belt 34b is secondarily transferred collectively onto recording paper P under the influence of the secondary transfer electrical field and a nip pressure, and is combined with the white color of the recording paper P, thereby being transformed into a full-color image.

After passing through the secondary transfer nip, the recording paper P separates from the intermediate transfer belt 34b to be conveyed toward the fixing unit 36 in conjunction with the circular movement of the paper conveying belt 35c while being held on the outside surface thereof. When having passed through the secondary transfer nip, the intermediate transfer belt 34b has transfer residual toner adhering to the outside surface thereof, which has not been transferred onto the recording paper P at the secondary transfer nip. This transfer residual toner is removed by being scraped by a belt cleaning device 16, which makes contact with the intermediate transfer belt 34b.

After being conveyed to the fixing unit 36, the recording paper P is subjected to heat application and pressure application inside the fixing unit 36 to have the full-color image fixed thereon, and is then fed from the fixing unit 36 to the finisher 6.

As illustrated in FIG. 3, the process units 30 in the image forming unit 3 have structures that are substantially the same except that the colors of toners used in the respective units are different. For this reason, FIG. 3 omits sign denotations K, Y, M, and C that differentiate the colors of any adjacent ones of the process units 30 in the illustration.

Each of the process units 30 is constructed of the photoconductor drum 32, the developing device 33, and other parts arranged around the photoconductor drum 32 such as the drum cleaning device 11, a discharging lamp 12, and a charging roller 13.

In each of the process units 30, the photoconductor drum 32 is a drum-shaped member composed of: an element tube made of aluminum or the like; and a photosensitive layer formed on the element tube by applying thereto an organic photosensitive material that has photosensitivity.

The photoconductor drum 32 is exposed to a laser beam L generated by the exposure device 31, so that an electrostatic image corresponding to a read image for a corresponding color is formed on a surface layer part of the photoconductor drum 32.

The developing device 33 includes: a developing case 33c housing therein two-component developer (not illustrated) that contains a magnetic carrier and non-magnetic toner; and stirring screws 33b that supply the two-component developer to a developing sleeve 33a while stirring the developer.

The developing device 33 includes a magnet (not illustrated) or the like located in the interior of the developing sleeve 33a, and some part of the toner in the two-component developer is thus carried in a lamellar form by the developing sleeve 33a. Thus, the lamellar toner carried on the developing sleeve 33a can be transferred onto an electrostatic latent image formed on the photoconductor drum 32.

Residual toner after the developing is brought back into the developing case 33c as a result of rotation of the developing sleeve 33a, and separates from a surface of the developing sleeve 33a by the action of a repelling magnetic field formed by the foregoing magnet. An adequate amount of toner is then resupplied to two-component developer on the basis of a toner concentration detected by a toner concentration sensor 33d in the developing case 33c.

The drum cleaning device 11 includes: a rubber cleaning blade 11a made of polyurethane rubber, which is pressed against the outer circumferential surface of the photoconductor drum 32; and a contact-conductive fur brush 11b, which makes contact with the outer circumferential surface of the photoconductor drum 32. The drum cleaning device 11 further includes: a metallic electrical-field roller 11c, which makes contact with the fur brush 11b and rotates in a counter direction thereto; a scraper 11d, which is pressed against the electrical-field roller 11c; and a collection screw 11e located under the scraper 11d. The electrical-field roller 11c applies a bias to the fur brush 11b.

Toner left on the outer circumferential surface of the photoconductor drum 32 attaches to the fur brush 11b and then transfers to the electrical-field roller 11c to be scraped off by the scraper 11d. The toner thus scraped off is delivered from the inside of the drum cleaning device 11 to an external recycling conveyance device by the collection screw 11e.

The discharging lamp 12 optically irradiates and thereby discharges the thus cleaned outer circumferential surface of the photoconductor drum 32. The charging roller 13 evenly charges the thus discharged outer circumferential surface of the photoconductor drum 32. On the thus evenly charged outer circumferential surface of the photoconductor drums 32, optical writing is performed with a laser beam L received from the exposure device 31.

Under each of the photoconductor drums 32, a corresponding one of the primary transfer rollers 34a that causes the endless intermediate transfer belt 34b to move in an orbit while making contact with the photoconductor drums 32 is arranged.

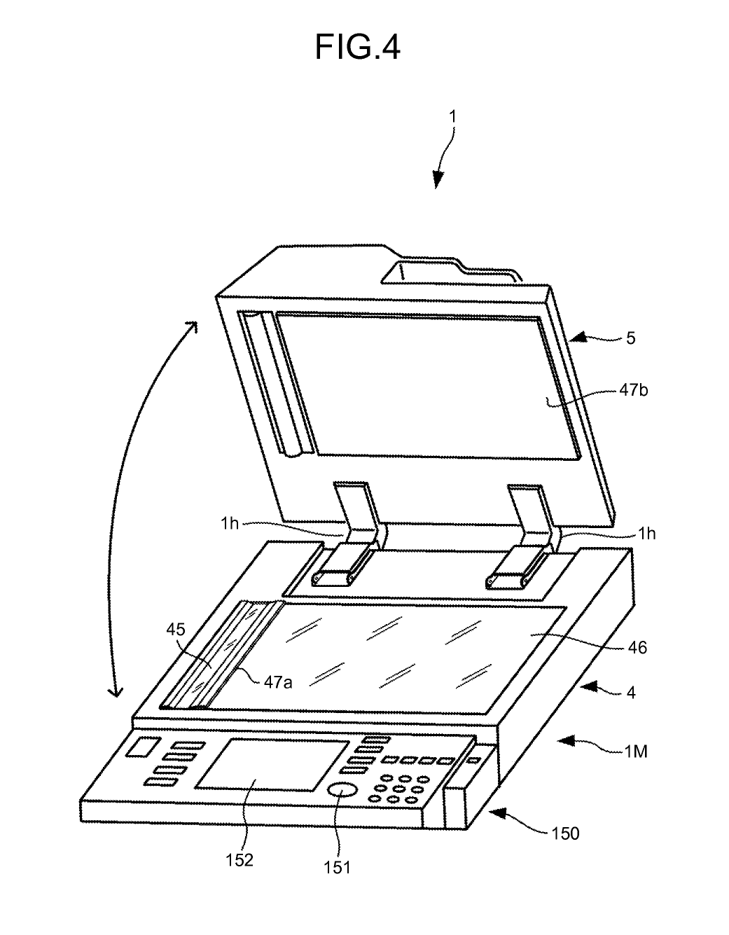

As illustrated in FIG. 4, the image reading unit 4 is located on the top of the apparatus main body 1M of the image forming apparatus 1. The image reading unit 4 includes: the first contact glass 45 located in a conveyance route of document sheets S; the second contact glass 46 on which a document sheet S is placed; and the bump member 47a which can be bumped by and position one side of a document sheet S. Additionally, the apparatus main body 1M has an operation unit 150 installed in the front side on the top thereof.

The operation unit 150 includes, for example, a print key 151 and a touch panel 152, and requests the image forming apparatus 1 to start copying operation when the print key 151 is pressed down.

The automatic document feeding unit 5 is joined to the upper part of the apparatus main body 1M of the image forming apparatus 1 by a hinge mechanism 1h so as to be openable and closable, and has a document retainer 47b on the underside surface thereof. The automatic document feeding unit 5 is operated to swing between the opened position at which the first contact glass 45 and the second contact glass 46 in the image reading unit 4 are exposed, and the closed position at which the first contact glass 45 and the second contact glass 46 are covered.

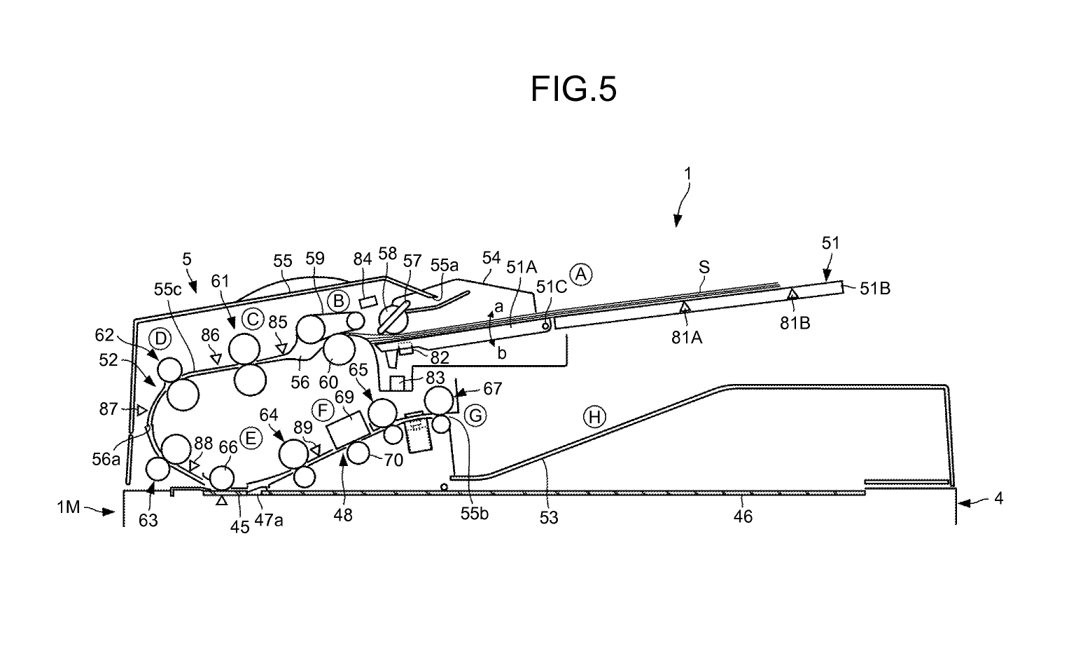

As illustrated in FIG. 5, the automatic document feeding unit 5 is constructed as a sheet-through automatic document feeder. The automatic document feeding unit 5 includes: the document table 51 provided as a table on which to place documents; the document conveying unit 52 composed of various rollers, a guide member, and the like; and the document paper ejection tray 53 on which to accumulate document sheets S after image reading.

The automatic document feeding unit 5 includes a document setting unit A, a separating and feeding unit B, a registration unit C, a turn unit D, a first reading and feeding unit E, a second reading and feeding unit F, a paper ejecting unit G, and a stack unit H as a plurality of functional units.

The document setting unit A has a table-like shape that allows placement thereon of at least one document sheet S formed as a cut sheet, which is a bundle of a plurality of document sheets S, for example. When a document sheet S is a single-sided document, the document sheet S is placed, with its front surface facing upward, on the document setting unit A.

The separating and feeding unit B separates the uppermost sheet from the bundle of document sheets S placed on the document setting unit A from the other sheets, and feeds the separated sheet to an entrance of a document conveying route 56 to be described later.

The registration unit C has a function of aligning, in a required orientation for conveyance, document sheets S sequentially fed from the separating and feeding unit B by primarily causing the sheets to bump, and a function of pulling out and conveying the thus aligned document sheets S toward the downstream side.

The turn unit D has a reversing conveyance function of turn-around feeding of turning upside down a document sheet S pulled out and conveyed by the registration unit C, thereby making the front surface of the document sheet S downward-facing in FIG. 5.

After a document sheet S is turned around by the turn unit D, the first reading and feeding unit E feeds the document sheet S at a certain speed in a sub-scanning direction (a direction perpendicular to a main-scanning direction, which is the width direction of the document) while causing it to pass through a reading position on the first contact glass 45.

When a document sheet S is a two-sided document, the second reading and feeding unit F subjects an back-surface image thereon to main scanning from an obliquely upper and left position in FIG. 5 through a platen glass (not illustrated) at a position downstream of where an front-surface image thereon is subjected to main scanning, and then feeds the document sheet S in the sub-scanning direction at a certain speed.

After image reading of a document sheet S in the first reading and feeding unit E and the second reading and feeding unit F, the paper ejecting unit G ejects the document sheet S toward the stack unit H.

The stack unit H sequentially accumulates thereon document sheets S sequentially ejected from the paper ejecting unit G with the front surfaces of the document sheets S facing downward. The document sheets S accumulated on the stack unit H are stacked on one another in the same sequence of pages as when they have been placed on the document setting unit A, in such manner that the whole bundle has document surfaces reversed.

These document setting unit A, separating and feeding unit B, registration unit C, turn unit D, first reading and feeding unit E, second reading and feeding unit F, paper ejecting unit G, and stack unit H are controlled by a controller unit for controlling automatic document feeding to be described later.

The automatic document feeding unit 5 separates one sheet from another in the uppermost part of a document bundle of document sheets S placed on the document table 51, and causes the document feeding unit 52 to feed the document sheet S through a certain feeding route that passes above the first contact glass 45. The automatic document feeding unit 5 causes the image reading unit 4 to read an image on a document sheet S when the document sheet S passes the first contact glass 45, and then ejects the document sheet S onto the document paper ejection tray 53.

The document table 51 on which to place document sheets S with the sheets S facing upward is arranged in an inclined manner with one side thereof that faces the document feeding unit 52 corresponding to the front end side of the document sheets S so that the front end side can be lower and the rear end side can be higher in position.

The document table 51 is divided into a movable document table 51A and a rearward document table 51B. The movable document table 51A swings with a shaft 51C at the center of the swing in such a manner that its front end tilts more downward as a bundle of document sheets S thereon is thicker. The movable document table 51A swings upward and downward as indicated by the arrows a and b, respectively, in FIG. 5 when a bottom-plate elevating motor to be described later is actuated.

The movable document table 51A includes side guide plates 54 that position sides of document sheets S in leftward and rightward directions perpendicular to the paper feeding direction while the document sheets S are moving toward the document feeding unit 52. The side guide plates 54 are a pair of guide plates arranged so as to be able to be relatively closer to and farther from each other in a width direction of the movable document table 51A so that respective referential positions of the movable document table 51A and each of the document sheets S coincide with each other in the width direction.

The document feeding unit 52 is covered by a cover 55. At least the upper side of the cover 55 is openable and closable. The cover 55 includes a paper feeding port 55a so that the front ends of the document sheets S can face the inside of the cover. Additionally, the cover 55 covers the upper side of the frond end of the movable document table 51A so that the front end of the movable document table 51A can be positioned deeper inside than the paper feeding port 55a.

In the document feeding unit 52, a range extending from the paper feeding port 55a to the paper ejection port 55b, which is located above the document paper ejection tray 53, is covered by members, such as guide members including a rib 55c, formed in the cover 55 and the like, thereby forming the document conveying route 56.

The document feeding unit 52 includes a set filler 57 above the front end of the movable document table 51A, which is located upstream of the paper feeding port 55a side with respect to a direction in which the document sheets S are conveyed. The set filler 57 is caused to swing by document sheets S placed on the movable document table 51A. The document feeding unit 52 further includes: a pickup roller 58 located on the inner side than and near the paper feeding port 55a; and an endless paper feeding belt 59 and a reverse roller 60 (paper feeding unit) arranged so as to face each other across the document conveying route 56.

The pickup roller 58 is driven by a pickup motor to be described later, and frictionally conveys and picks up, at a contact position, the uppermost few sheets (ideally one sheet) from the document sheets S placed on the document table 51.

The paper feeding belt 59 moves in an orbit by being driven by a paper feeding motor to be described later, and moves along the document feeding direction at one side thereof.

The reverse roller 60 is rotatable in a direction the reverse of the document feeding direction of the paper feeding belt 59, and has a torque limiter embedded therein. The reverse roller 60 makes contact with the paper feeding belt 59 with certain pressure, and corotates counterclockwise following the rotation of the paper feeding belt 59 when making direct contact with the paper feeding belt 59 or contact therewith with one document sheet S therebetween.

When a plurality of document sheets S have entered an interstice between the paper feeding belt 59 and the reverse roller 60, the power of the reverse roller 60 to corotate counterclockwise is reduced to a level lower than a set torque of the torque limiter. Thus, the reverse roller 60 presses excess document sheets S back to prevent overlapped document sheets S from being fed.

The document feeding unit 52 includes a plurality of pairs of conveyance rollers 61 to 65 that nip a document sheet S between each paired rollers with each paired rollers facing each other across the document conveying route 56. Each of the pairs of conveyance rollers 61 to 65 includes, for example, a pair of rollers or larger and smaller rollers that are close to each other in the radial directions thereof, and the number of rollers arranged in axial directions thereof is any desirable number. The numbers and positions of the conveyance rollers 61 to 65 arranged are determined as appropriate depending on such factors as: a routing design of the document conveying route 56; and a length of a document sheet S in the document feeding direction when the document sheet S has the smallest size allowed by the automatic document feeding unit 5.

The conveyance rollers 61 arranged in a downstream part of the paper feeding belt 59 and adjacently to each other function as pullout rollers. More specifically, the conveyance rollers 61 are bumped by and correct skew of the front end of a fed document sheet S in accordance with the moments when the pickup roller 58 is driven, and pull out and convey the document sheet S the skew of which has been corrected.

The conveyance rollers 61 are provided for conveying a document sheet S to the conveyance rollers 62 located intermediately, and are driven by reverse rotation of the paper feeding motor. During this reverse rotation of the paper feeding motor, the conveyance rollers 61 and 62 are driven, and the pickup roller 58 and the paper feeding belt 59 are not driven.

The conveyance rollers 62 in the second stage act as turn rollers by which the document sheet S pulled out and conveyed is caused to enter a turn portion 56a located intermediarily in the document conveying route 56.

A conveyance speed at which a document sheet S is conveyed from the registration unit C to the turn unit D when the conveyance rollers 61 and 62 are driven is set higher than a conveyance speed of the document sheet S in the first reading and feeding unit E. Thus, a time for a process of feeding a document sheet S to the first reading and feeding unit E can be reduced.

The conveyance roller 63 arranged downstream of the turn portion 56a in the document conveying route 56 act as reading entrance rollers by which document sheets S having passed the turn portion 56a are sequentially fed out onto the first contact glass 45. After passing the first contact glass 45, the document sheet S is conveyed by the conveyance rollers 64 acting as first reading exit rollers toward the second surface reading unit 48 to be described later, and then is further conveyed toward the paper ejection port by the conveyance rollers 65 located further downstream, which act as second reading exit rollers.

The document feeding unit 52 further includes: a first reading roller 66 arranged above and so as to face the first contact glass 45; and paper ejection rollers 67 that are arranged near the paper ejection port 55b and eject document sheets S through the paper ejection port 55b toward the document paper ejection tray 53.

The first reading roller 66 is biased toward the first contact glass 45 by use of a biasing member such as a coil spring (not illustrated). When a document sheet S is conveyed, this first reading roller 66 moves the document sheet S entering onto the first contact glass 45 toward the further downstream side while keeping the document sheet S in tight contact with the first contact glass 45.

The document feeding unit 52 has the second surface reading unit 48 at a location downstream of the first reading roller 66 and within a document feeding region that is relatively rectilinear and located between the conveyance rollers 64 and the conveyance rollers 65.

The second surface reading unit 48 includes: a back surface scanning unit 69 that reads a back-surface image on a document sheet S; the shading roller 70 facing the back surface scanning unit 69 across the document conveying route 56; and a conveyance-gap adjuster (not illustrated).

The back surface scanning unit 69 is constructed of, for example, a contact image sensor (CIS), and reads an image on the back surface (a second surface) of a document sheet S after an image on the front surface (a first surface) of the document sheet S is read by the imaging unit 44 of the image reading unit 4.

The shading roller 70 prevents a document sheet S from surging at the back surface scanning unit 69 and functions as a reference white portion for acquiring shading data at the back surface scanning unit 69. When reading a back-surface image on a document sheet S is not performed, a document sheet S passes the back surface scanning unit 69 without being subjected to any process.

The above-described conveyance-gap adjuster is, for example, added to a bearing that supports the shading roller 70, and enables adjustment of a gap between the back surface scanning unit 69 and the shading roller 70. Thus, the focus depth of the back-surface scanning unit 69 can be kept from deteriorating the reading image quality.

To the document table 51, a first document-length detecting sensor 81A and a second document-length detecting sensor 81B that detect whether the orientation of a document sheet S placed on the document table 51 is portrait or landscape are provided with a distance therebetween extending in the feeding direction.

For example, when used in combination with a detection sensor (not illustrated) that detects the distance between the side guide plates 54 facing each other, the first document-length detecting sensor 81A and the second document-length detecting sensor 81B can detect the size of a document sheet S placed on the document table 51.

Near the bottom face of the document table 51 near the front end thereof, a document set sensor 82 is provided that detects the lowermost portion of the front end of the set filler 57 on a trajectory travelled by that front end, thereby detecting whether a document sheet S is placed on the document table 51. The document set sensor 82 is configured to detect the lowermost portion of the front end of the set filler 57 on a trajectory travelled by that front end.

Below the front end of the movable document table 51A, a home position sensor 83 is provided. This home position sensor 83 is configured to detect when the movable document table 51A has swung downward and reached a home position.

In the document feeding unit 52, a table elevation detecting sensor 84, a bumping sensor 85, a document width sensor 86, a reading entrance sensor 87, a registration sensor 88, and a paper ejection sensor 89 are arranged in order from the upstream side to the downstream side in the direction in which document sheets S are conveyed.

The table elevation detecting sensor 84 is configured to detect the position of the upper surface of a bundle of documents on the movable document table 51A.

The bumping sensor 85 is arranged between the paper feeding belt 59 and the conveyance rollers 61, and is configured to detect the front end and the rear end of a document sheet S.

The document width sensor 86 is arranged between the conveyance rollers 61 and the conveyance rollers 62, and includes: a plurality of light-emitting elements arranged in the width direction of a document sheet S; and light-receiving elements arranged at positions facing these light-emitting elements across the document conveying route 56.

The reading entrance sensor 87, the registration sensor 88, and the paper ejection sensor 89 are used for such purposes as controlling, for example, the distance and speed of conveyance of a document sheet S, and detecting a paper jam.

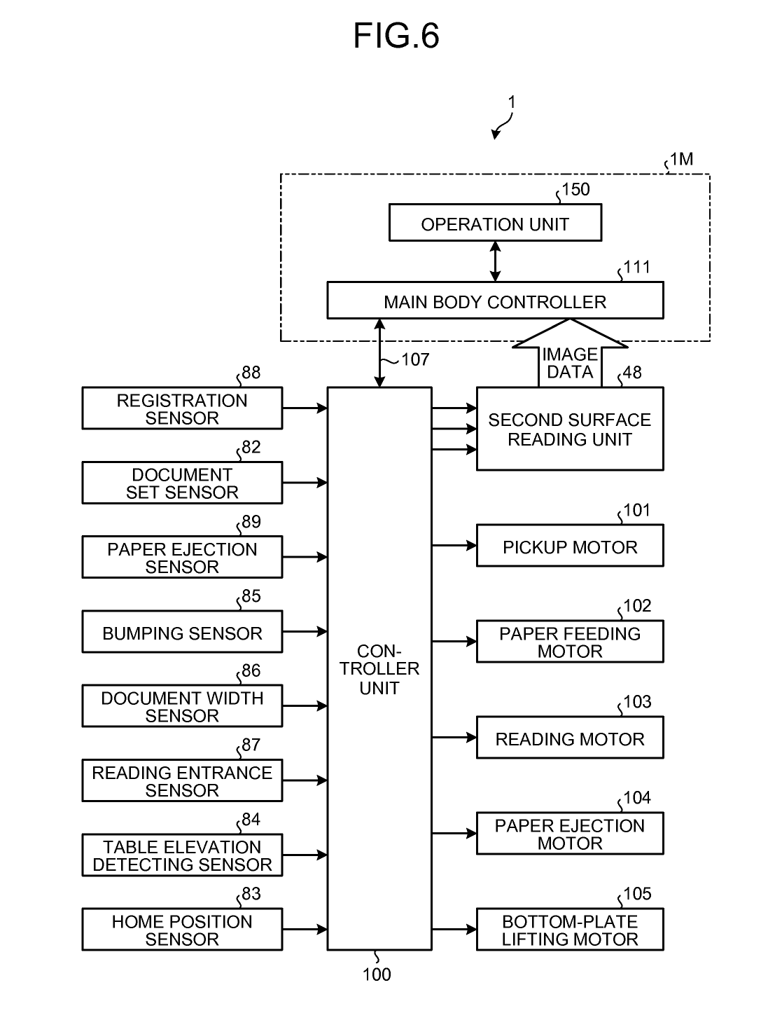

As illustrated in FIG. 6, the image forming apparatus 1 includes a controller unit 100 for automatic document feeing control, a main body controller 111, and the operation unit 150 appended to the main body controller 111.

The controller unit 100 receives detection signals from the document set sensor 82, the home position sensor 83, the table elevation detecting sensor 84, the bumping sensor 85, the document width sensor 86, the reading entrance sensor 87, the registration sensor 88, and the paper ejection sensor 89.

The controller unit 100 actuates a pickup motor 101 that drives the pickup roller 58, a paper feeding motor 102 that drives the paper feeding belt 59 and the conveyance rollers 61 and 62, and a reading motor 103 that drives the conveyance rollers 63 to 65. The controller unit 100 also actuates a paper ejection motor 104 that drives the paper ejection rollers 67, and a bottom-plate lifting motor 105 that lifts and lowers the movable document table 51A.

The controller unit 100 outputs, for example, timing signals to the second surface reading unit 48 for notification of times when the respective front ends of document sheets S reach the reading position of the back surface scanning unit 69 (image data obtained thereafter is treated as effective data).

The controller unit 100 and the main body controller 111 are connected to each other via an interface 107. The main body controller 111 transmits such signals as a document paper feeding signal and a reading start signal to the controller unit 100 via the interface 107 when the print key 151 in the operation unit 150 is pressed down.

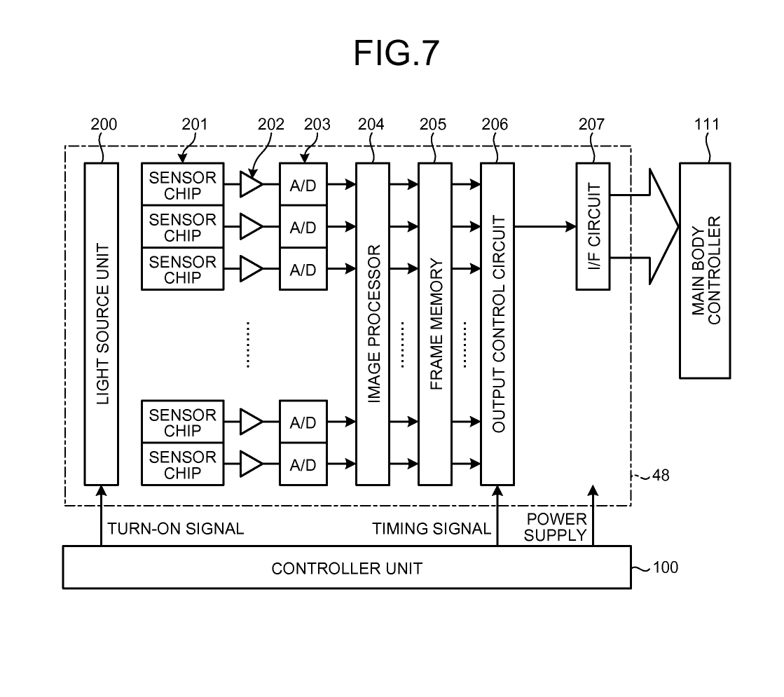

As illustrated in FIG. 7, the second surface reading unit 48 includes a light source unit 200 constructed of, for example, a light-emitting diode (LED) array, a fluorescent lamp, or a cold cathode tube. The light source unit 200 irradiates document sheets S with light on the basis of a turn-on signal from the controller unit 100. The second surface reading unit 48 receives, from the controller unit 100, timing signals for notification of times when the respective front ends of document sheets S reach the reading position of the back surface scanning unit 69 and power supply for the light source unit 200.

The second surface reading unit 48 includes: a plurality of sensor chips 201 lined up in the main-scanning direction; a plurality of operational (OP) amplifier circuits 202 individually connected to the respective sensor chips 201; and a plurality of analog-digital (A/D) converters 203 individually connected to the respective OP amplifier circuits 202. The second surface reading unit 48 further includes an image processor 204, a frame memory 205, an output control circuit 206, and an interface circuit 207 (denoted as I/F CIRCUIT in FIG. 7).

Each of the sensor chips 201 includes: a photoelectric conversion element called an equal-magnification contact image sensor; and a condenser lens. Light reflected by the second surface of a document sheet S is concentrated to the photoelectric conversion element by the condenser lens in the sensor chip 201 to be read as image information.

Pieces of image information that have been read by the respective sensor chips 201 are amplified by the OP amplifier circuits 202, and then converted into respective pieces of digital image information by the A/D converters 203.

These pieces of digital image information are input into the image processor 204 to undergo processing such as shading correction, and thereafter temporarily stored in the frame memory 205. These pieces of digital image information are then converted by the output control circuit 206 into a data format acceptable to the main body controller 111, and thereafter output to the main body controller 111 via the interface circuit 207.

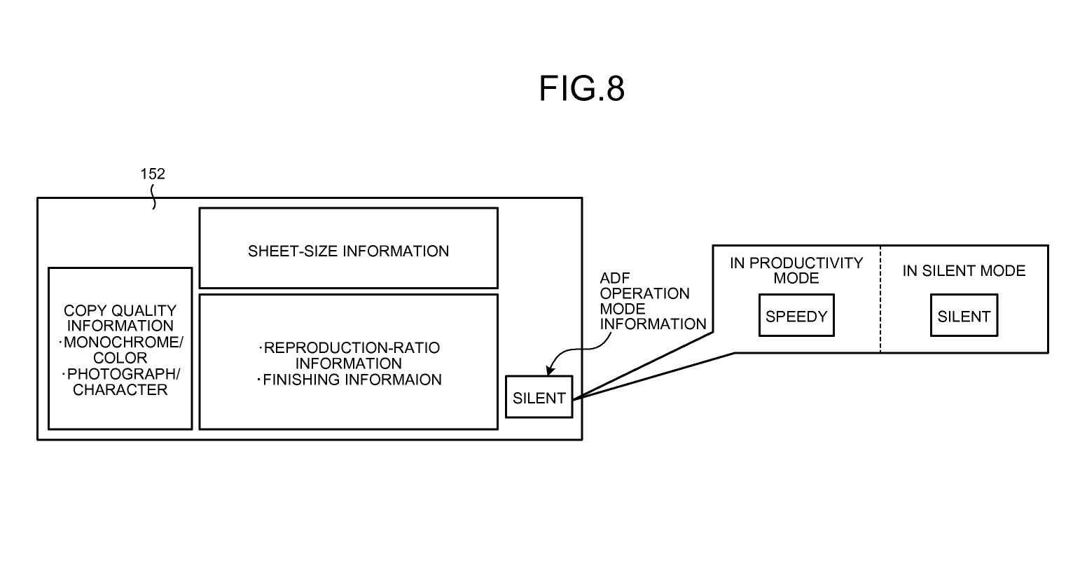

As illustrated in FIG. 8, the touch panel 152 of the operation unit 150 displays menus regarding, for example, sheet-size information, reproduction-ratio information, finishing information, copy quality information, selection between monochrome printing and color printing, and selection between a character document and a photograph document. The touch panel 152 also displays a menu regarding selection between a productivity mode and a silent mode, thereby enabling a user to select either of these modes. The touch panel 152 also displays a menu regarding selection between a copy mode and a scanner mode, thereby enabling a user to select either of these modes.

Furthermore, the touch panel 152 displays “speedy” in the form of characters when the productivity mode has been selected, and displays “silent” in the form of characters when the silent mode has been selected, for example. Thus, the user can recognize without fail which of the productivity mode and the silent mode has been selected. By having operation mode information of the ADF thus displayed on the touch panel 152 (a display unit), a user can check, without causing the screen to transition, a mode to which the ADF has been set until start of use of the image forming apparatus 1 and a mode to which it is currently set.

When a certain part of the touch panel 152 is pressed down, the operation unit 150 transmits a signal such as a reading mode signal corresponding to the scanner mode, a copy mode signal corresponding to the copy mode, a productivity mode signal, or a silent mode signal to the main body controller 111. When a certain part of the touch panel 152 is pressed down, the main body controller 111 transmits a corresponding one of the control signals including the productivity mode signal and the silent mode signal to the controller unit 100 via the interface 107. Thus, the controller unit 100 detects one mode of the productivity mode and the silent mode and therefore constitutes a detecting unit according to the present invention.

In general, the productivity in reading (documents read per minute) of an ADF is higher than the productivity in printing (copies per minute; hereinafter simply referred to as CPM) of the main body of an image forming apparatus. For this reason, when the main body of an image forming apparatus makes use of the copy function, a conveyance speed (paper feeding speed) of document sheets in an ADF can be set slower than the rated value thereof without affecting CPM.

With particular attention given to the above-described capability difference between the productivity in reading of the automatic document feeding unit 5 and the CPM of the apparatus main body 1M, the image forming apparatus 1 according to the present embodiment is configured to lower the paper feeding linear speed of document sheets S in the automatic document feeding unit 5 when the apparatus main body 1M makes use of the copy function.

However, a document sheet needs to move through each document reading position at a certain paper feeding speed according to the capability of a corresponding reading unit. Therefore, the paper feeding speed of document sheets is changed in a conveyance portion that does not affect reading of the documents.

More specifically, on the conveyance route from the document table 51 (a paper feeding tray) to the document paper ejection tray 53 (a paper ejection tray), in sections other than sections in each of which a document sheet S is present at least at either of the reading positions, the controller unit 100 changes each of the conveyance speeds in a first conveyance portion (A to D) and a second conveyance portion (G) from a first conveyance speed to a second conveyance speed slower than the first conveyance speed and vice versa. Therefore, reading of documents is not affected. Here, the reading positions include the reading position on the first contact glass 45 and the reading position of the back surface scanning unit 69.

The controller unit 100 also changes the conveyance speed of each of the rollers other than rollers that are nipping a document sheet S at the reading positions from a first conveyance speed to a second conveyance speed slower than the first conveyance speed and vice versa. This change not only does not affect reading of documents, but also can change the conveyance speed of a document subsequent to a document sheet S present at either of the reading positions. Here, the rollers that are nipping a document sheet S include the conveyance rollers 63, the conveyance rollers 64, and the conveyance rollers 65.

An automatic document feeder is connectable to the main bodies of a plurality of image forming apparatuses. In an automatic document feeder serving as a peripheral device for common use, conveyance speeds are set so as to correspond to the main bodies of the image forming apparatuses because productivity in printing varies by model among the main bodies of the image forming apparatuses. Furthermore, in general, the productivity in reading of an automatic document feeder is set to a CPM value that is equal to or higher than that of a main body model having the highest CPM value. Thus, the image forming apparatus 1 is capable of setting the conveyance speed of the automatic document feeder slow during copying operation without affecting CPM. In consideration of this point, paper feeding speeds are set for the respective modes by main body model.

Thus, the controller unit 100 receives information on a corresponding model of each of a plurality of image forming apparatuses, and controls the first conveyance portion (A to D) and the second conveyance portion (G) so that previously set conveyance speeds can be implemented in accordance with the received model information.

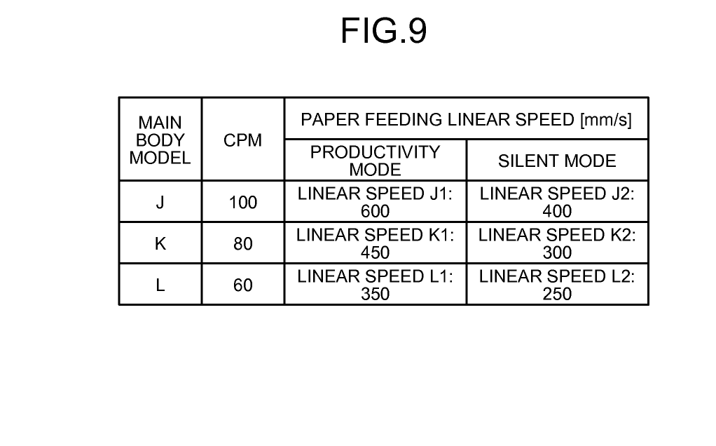

FIG. 9 represents paper feeding speeds determined for respective modes, which are the productivity mode and the silent mode, for each main body model.

As illustrated in FIG. 9, a read-only memory (ROM) of the controller unit 100 previously stores therein, with respect to each model of the device main bodies, information on the paper feeding linear speed of the automatic document feeding unit 5 for document sheets S in the productivity mode and information on the paper feeding linear speed of the automatic document feeding unit 5 for document sheets S in the silent mode. While the silent mode is an operational state in which noise during operation is reduced, the productivity mode is an operational state in which higher productivity in reading is achieved without reduction in noise during operation.

Here, the paper feeding linear speed in the productivity mode is the first conveyance speed in the present invention. On the other hand, the paper feeding linear speed in the silent mode is the second conveyance speed in the present invention. As illustrated in FIG. 9, productivity in printing (in CPM) varies among main body models J to K, and paper feeding speeds for the respective modes are set in accordance with CPM of each of the main body models. In this case, the paper feeding speeds for the silent mode for the respective device main bodies are previously set to desired values that do not reduce the CPM values of the main bodies of the image forming apparatuses. The paper feeding speeds for the productivity mode for the respective device main bodies are previously set to desired values. For example, in the case of the main body model J, the paper feeding linear speed for the productivity mode is set to 600 mm/s, and the paper feeding linear speed for the silent mode is set to 400 mm/s. Note that, although the information on these paper feeding linear speeds are stored in the ROM in the controller unit 100, it may be stored in the main body controller 111. In that case, the controller unit 100 acquires the paper feeding linear speeds from the main body controller 111.

In the main body controller 111, a selection between the productivity mode and the silent mode can be made through an initial setting screen on the touch panel 152. When a user selects the productivity mode by pressing down a specific part on the touch panel 152, the main body controller 111 causes the touch panel 152 to display the selected mode in the form of characters, and outputs the productivity mode signal to the controller unit 100. On the other hand, when a user selects the silent mode by pressing down a specific part on the touch panel 152, the main body controller 111 causes the touch panel 152 to display the selected mode in the form of characters, and outputs the silent mode signal to the controller unit 100.

Upon receiving a signal that is the productivity mode signal or the silent mode signal from the main body controller 111, the controller unit 100 controls the first conveyance portion (A to D), which is located upstream of a reading position in the conveyance direction, and the second conveyance portion (G) with previously set conveyance speeds.

More specifically, in the case of the main body model J, for example, upon detecting the productivity mode, the controller unit 100 controls the first conveyance portion (A to D) so that the conveyance speed in the first conveyance portion (A to D) can be the first conveyance speed. Upon detecting the silent mode, the controller unit 100 controls the first conveyance portion (A to D) so that the conveyance speed in the first conveyance portion (A to D) can be the second conveyance speed (400 mm/s) slower than the first conveyance speed (600 mm/s). Here, the document setting unit A, the separating and feeding unit B, the registration unit C, and the turn unit D constitute the first conveyance portion in the present invention.

On the other hand, in the case of the main body model J, for example, upon detecting the productivity mode, the controller unit 100 controls the second conveyance portion (G) so that the conveyance speed in the second conveyance portion (G) can be the first conveyance speed (600 mm/s). Upon detecting the silent mode, the controller unit 100 controls the second conveyance portion (G) so that the conveyance speed in the second conveyance portion (G) can be the second conveyance speed (400 mm/s) slower than the first conveyance speed (600 mm/s). Thus, the paper ejecting unit G constitutes the second conveyance portion in the present invention. Note that the model information is received from the main body of an image forming apparatus when the power supply to the image forming apparatus 1 is turned on.

Upon receiving the document paper feeding signal and the reading start signal, the controller unit 100 sequentially actuates the pickup motor 101, the paper feeding motor 102, the reading motor 103, and the paper ejection motor 104.

Upon receiving the document paper feeding signal in the productivity mode, the controller unit 100 controls the pickup motor 101, the paper feeding motor 102, and the paper ejection motor 104 so that document sheets S can be conveyed at a paper feeding linear speed for the productivity mode in the range from the document setting unit A to the turn unit D.

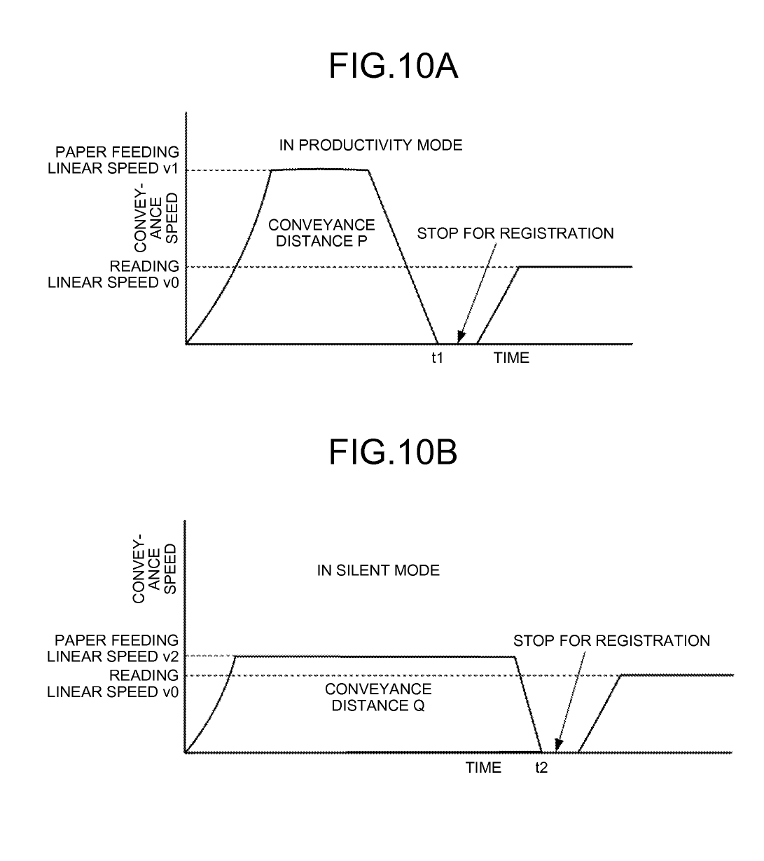

As illustrated in FIG. 10A, the controller unit 100 raises the conveyance speed of document sheets S in a standstill state to a paper feeding linear speed v1 and conveys the document sheets S at a constant speed. Subsequently, when the front end of a document is detected by the reading entrance sensor 87, the controller unit 100 lowers the conveyance speed of the document sheets S, thrusts the front end of the document sheet S into the nip between the conveyance rollers 63 located upstream of the first reading and feeding unit E, and then stops the document sheet S for registration.

Upon receiving the reading start signal, the controller unit 100 actuates the reading motor 103 so that document sheets S can be conveyed at a reading linear speed in the range from the first reading and feeding unit E to the second reading and feeding unit F.

As illustrated in FIG. 10A, the controller unit 100 raises the conveyance speed of the document sheet S having been stopped for registration to a reading linear speed v0 and conveys the document sheet S at a constant speed. The controller unit 100 further actuates the paper ejection motor 104 so that document sheets S can be conveyed at the paper feeding linear speed for the productivity mode in the range of the paper ejecting unit G, thereby ejecting the document sheet S after image reading onto the document paper ejection tray 53 acting as the stack unit H.

Upon receiving the document paper feeding signal in the silent mode, the controller unit 100 controls the pickup motor 101, the paper feeding motor 102, and the paper ejection motor 104 so that document sheets S can be conveyed at a paper feeding linear speed for the silent mode in the range from the document setting unit A to the turn unit D.

As illustrated in FIG. 10B, the controller unit 100 raises the conveyance speed of document sheets S in a standstill state to a paper feeding linear speed v2 and conveys the document sheets S at a constant speed. Subsequently, when the front end of a document is detected by the reading entrance sensor 87, the controller unit 100 lowers the conveyance speed of the document sheets S, thrusts the front end of the document sheet S into the nip between the conveyance rollers 63 located upstream of the first reading and feeding unit E, and then stops the document sheet S for registration.

Upon receiving the reading start signal, the controller unit 100 actuates the reading motor 103 so that document sheets S can be conveyed at a reading linear speed in the range from the first reading and feeding unit E to the second reading and feeding unit F.

As illustrated in FIG. 10B, the controller unit 100 raises the conveyance speed of the document sheet S having been stopped for registration to a reading linear speed v0 and conveys the document sheet S at a constant speed. The controller unit 100 further actuates the paper ejection motor 104 so that document sheets S can be conveyed at the paper feeding linear speed for the silent mode in the range of the paper ejecting unit G, thereby ejecting the document sheet S after image reading onto the document paper ejection tray 53 serving as the stack unit H.

The paper feeding linear speed v1 for the productivity mode and the paper feeding linear speed v2 for the silent mode satisfy v1>v2. Additionally, a time t1 from the start of conveyance of document sheets S to the stopping for registration in the productivity mode and a time t2 from the start of conveyance of document sheets S to the stopping for registration in the silent mode satisfy t2>t1.

Therefore, the controller unit 100 needs to actuate the pickup motor 101 and the paper feeding motor 102 so that a conveyance distance P calculated by the conveyance speed×the time in the productivity mode can be equal to a conveyance distance Q calculated by the conveyance speed×the time in the silent mode. Here, the same applies to the paper ejection motor 104. Note that, as to the paper ejection motor 104, conveyance may be performed at a certain paper feeding linear speed regardless of mode.

Furthermore, the controller unit 100 detects passage of the rear end of a document sheet S by way of a paper ejection sensor (not illustrated) provided downstream of the back surface scanning unit 69, and controls the paper ejection motor 104 so that the document sheets S can be conveyed at the paper feeding linear speed for each of the modes in the range of the paper ejecting unit G.

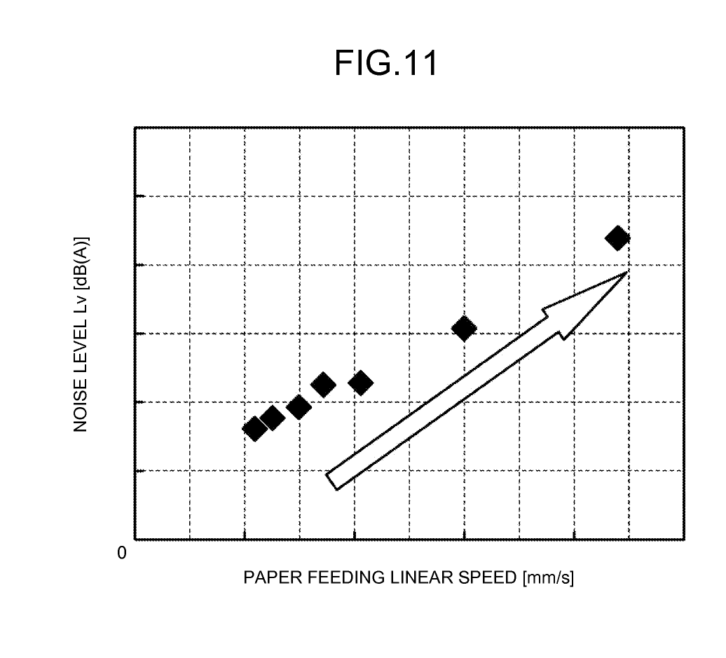

As illustrated in FIG. 11, in the image forming apparatus 1 according to the present embodiment, noise caused when the automatic document feeding unit 5 conveys document sheets S from the document setting unit A to the turn unit D is louder when the conveyance speed of the document sheets S is higher, as is clear from the square marks. This noise is attributable to, for example, machine noise of the pickup motor 101 and the paper feeding motor 102 and friction noise of document sheets S with the pickup roller 58, the paper feeding belt 59, the reverse roller 60, and the conveyance rollers 61 and 62. The same applies to the paper ejecting unit G.

The controller unit 100 in the image forming apparatus 1 according to the present embodiment, upon detecting the silent mode signal, controls the automatic document feeding unit 5 so that document sheets S can be conveyed at a paper feeding linear speed for the silent mode in the range from the document setting unit A to the turn unit D. The controller unit 100, upon detecting the silent mode signal, further controls the automatic document feeding unit 5 so that document sheets S can be conveyed at a paper feeding linear speed corresponding to the silent mode in the range of the paper ejecting unit G.

In the image forming apparatus 1 according to the present embodiment, the conveyance speed of document sheets S is slower and noise attributable to machine noise, friction noise, and the like in the automatic document feeding unit 5 is smaller in the silent mode than in the productivity mode. In this mode, the conveyance speed of recording paper P in the apparatus main body 1M is not slowed down, and there is no reduction in the productivity in printing of the apparatus main body 1M.

Thus, the image forming apparatus 1 according to the present embodiment allows for noise reduction without reduction in the productivity in printing.

The controller unit 100 in the image forming apparatus 1 according to the present embodiment, upon detecting the productivity mode signal, controls the automatic document feeding unit 5 so that document sheets S can be conveyed at a paper feeding linear speed for the productivity mode in the range from the document setting unit A to the turn unit D. The controller unit 100, upon detecting the productivity mode signal, further controls the automatic document feeding unit 5 so that document sheets S can be conveyed at a paper feeding linear speed corresponding to the productivity mode in the range of the paper ejecting unit G.

In the image forming apparatus 1 according to the present embodiment, the conveyance speed of document sheets S in the automatic document feeding unit 5 is higher in the productivity mode than in the silent mode.

Thus, the image forming apparatus 1 according to the present embodiment allows for effective image reading of document sheets S in the case of making use of the copy function in the productivity mode and in the case of making use of the scanner function or the facsimile function of the apparatus main body 1M.

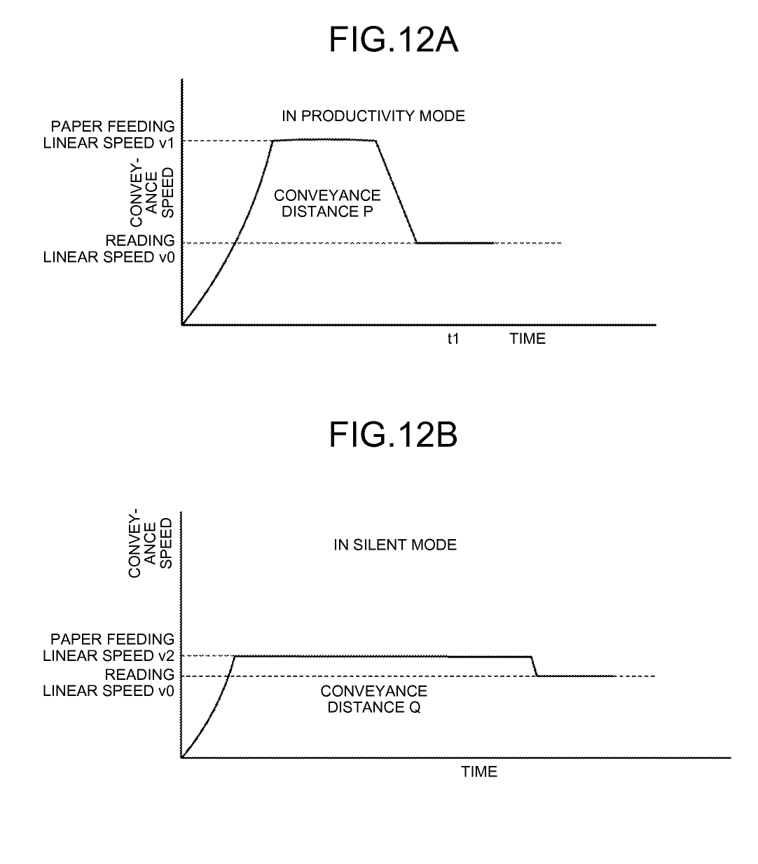

The controller unit 100 can also control the conveyance speed of document sheets S in the automatic document feeding unit 5 so that the document sheets S may not be stopped for registration as in the example illustrated in FIGS. 12A and 12B, unlike the example illustrated in FIGS. 10A and 10B.

As illustrated in FIG. 12A, in the productivity mode, the controller unit 100 raises the conveyance speed of document sheets S in a standstill state to a paper feeding linear speed v1 and conveys the document sheets S at a constant speed. Subsequently, the controller unit 100 lowers the conveyance speed of the document sheets S to a reading speed v0, thrusts the front end of the document sheet S into the nip between the conveyance rollers 63, and then feeds the document sheets S at a constant speed to the first reading and feeding unit E and the second reading and feeding unit F.

As illustrated in FIG. 12B, in the silent mode, the controller unit 100 raises the conveyance speed of document sheets S in a standstill state to a paper feeding linear speed v2 and conveys the document sheets S at a constant speed. Subsequently, the controller unit 100 lowers the conveyance speed of the document sheets S to a reading speed v0, thrusts the front end of the document sheet S into the nip between the conveyance rollers 63, and then feeds the document sheets S at a constant speed to the first reading and feeding unit E and the second reading and feeding unit F.

Thus, the image forming apparatus 1 according to the present embodiment allows for noise reduction without reduction in the productivity in printing even with the conveyance speed of document sheets S in the automatic document feeding unit 5 controlled as illustrated in FIGS. 12A and 12B.

The controller unit 100 sets the silent mode as a mode at factory shipment of the image forming apparatus 1, or as a default mode, out of the productivity mode and the silent mode. Thus, the image forming apparatus 1 allows for noise reduction without reduction in the productivity in printing in so far as a user particularly selects the productivity mode at initial setting.

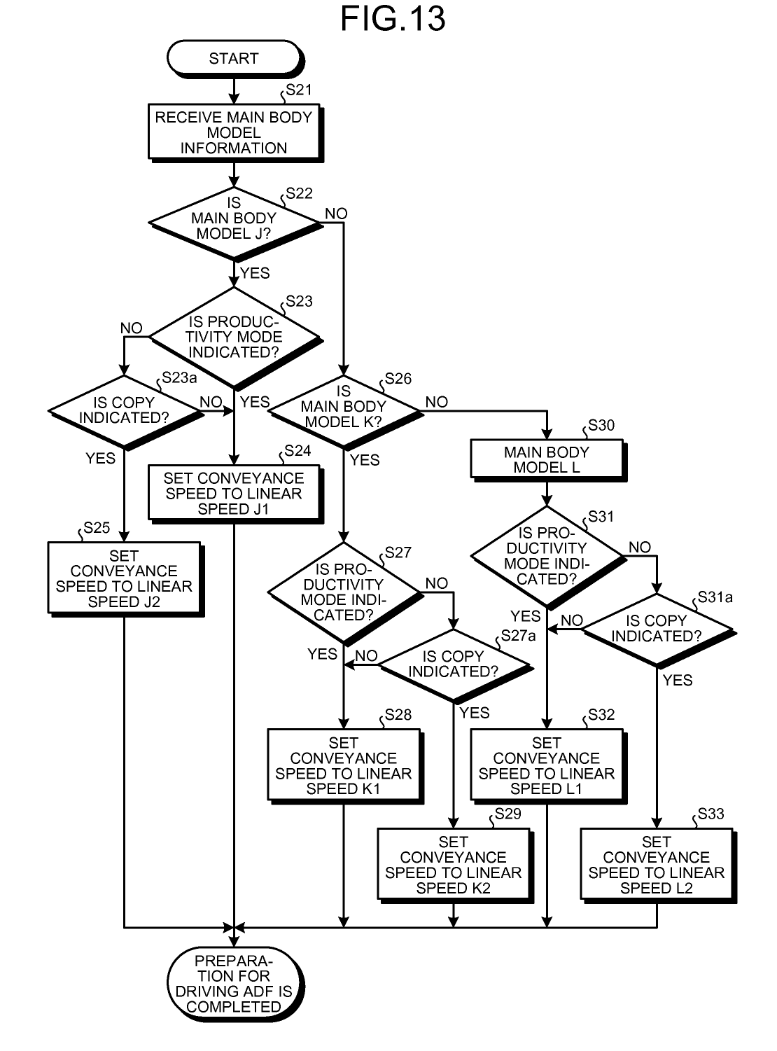

FIG. 13 indicates processing of setting the conveyance speed of document sheets that the controller unit 100 according to the present embodiment executes.

The controller unit 100 of the automatic document feeding unit 5 has a total of three main bodies of image forming apparatuses connected thereto, the models of which are: a main body model J, the productivity in printing (CPM, i.e., copies per minute) of which is 100; a main body model K, the CPM of which is 80; and a main body model L, the CPM of which is 60. For the convenience of explanation, the following describes a case where only one of the main body models J, K, and L is selectively powered on.

The controller unit 100 receives main body model information from main body controllers of the main body models J, K, and L, and may be configured to receive information on paper feeding linear speeds for the productivity mode and information on paper feeding linear speeds for the silent mode in addition to the information on the respective main body models. The controller unit 100 detects the productivity mode signal and the silent mode signal transmitted from the main body controllers of the main body models J, K, and L.

As illustrated in FIG. 13, when only one of the main body models J, K, and L is selectively powered on, the controller unit 100 receives the main body model information from the main body model that has been turned on (Step S21).

Upon receiving the main body model information of the main body model J (Yes at Step S22), the controller unit 100 detects whether the productivity mode signal has been transmitted from the main body controller of the main body model J (Step S23).

Upon detecting the productivity mode signal (Yes at Step S23), the controller unit 100 sets the conveyance speed of document sheets to a linear speed J1 for the productivity mode (Step S24), thereby completing preparation for driving the ADF.

When not having detected the productivity mode signal (No at Step S23), the controller unit 100 detects whether the copy mode signal has been transmitted from the main body controller of the main body model J (Step S23a).

Upon detecting the copy mode signal (Yes at Step S23a), the controller unit 100 sets the conveyance speed of document sheets to a linear speed J2 for the silent mode (Step S25), thereby completing preparation for driving the ADF.

When not having detected the copy mode signal (No at Step S23a), the controller unit 100 sets the conveyance speed of document sheets to the linear speed J2 for the silent mode (Step S25), thereby completing preparation for driving the ADF.

When not having received the main body model information of the main body model J (No at Step S22), upon receiving the main body model information of the main body model K (Yes at Step S26), the controller unit 100 detects whether the productivity mode signal has been transmitted from the main body controller of the main body model K (Step S27).

Upon detecting the productivity mode signal (Yes at Step S27), the controller unit 100 sets the conveyance speed of document sheets to a linear speed K1 for the productivity mode (Step S28), thereby completing preparation for driving the ADF.

When not having detected the productivity mode signal (No at Step S27), the controller unit 100 detects whether the copy mode signal has been transmitted from the main body controller of the main body model K (Step S27a).

Upon detecting the copy mode signal (Yes at Step S27a), the controller unit 100 sets the conveyance speed of document sheets to a linear speed K2 for the silent mode (Step S29), thereby completing preparation for driving the ADF.

When not having detected the copy mode signal (No at Step S27a), the controller unit 100 sets the conveyance speed of document sheets to the linear speed K1 for the productivity mode (Step S28), thereby completing preparation for driving the ADF.

When not having received the main body model information of the main body model K (No at Step S26), upon receiving the main body model information of the main body model L (Yes at Step S30), the controller unit 100 detects whether the productivity mode signal has been transmitted from the main body controller of the main body model L (Step S31).

Upon detecting the productivity mode signal (Yes at Step S31), the controller unit 100 sets the conveyance speed of document sheets to a linear speed L1 for the productivity mode (Step S32), thereby completing preparation for driving the ADF.

When not having detected the productivity mode signal (No at Step S31), the controller unit 100 detects whether the copy mode signal has been transmitted from the main body controller of the main body model L (Step S31a).

Upon detecting the copy mode signal (Yes at Step S31a), the controller unit 100 sets the conveyance speed of document sheets to a linear speed L2 for the silent mode (Step S33), thereby completing preparation for driving the ADF.

When not having detected the copy mode signal (No at Step S31a), the controller unit 100 sets the conveyance speed of document sheets to the linear speed L1 for the productivity mode (Step S32), thereby completing preparation for driving the ADF.

Thus, while silent operation has been given increasingly higher priority over productivity in line with usage environments and user preferences, the silent mode in which the conveyance speed is lowered for reduction of drive noise and noise from document conveyance is selectable by user settings in addition to the productivity mode, which is a usual mode.

Not only that, a conveyance speed for the productivity mode and a conveyance speed for the silent mode with respect to each main body model can be easily set with the application of the document sheet conveyance speed setting processing in FIG. 13 to the image forming apparatus 1 in which the automatic document feeding unit 5 has the main body models J, K, and L connected thereto.

Note that Step S23a, Step S27a, and Step S31a are not needed when the above respective processes are started for copying, and the processing proceeds to Step S25, Step S29, and Step S33 in the cases of “No” at Step S23, Step S27, and Step S31, respectively.

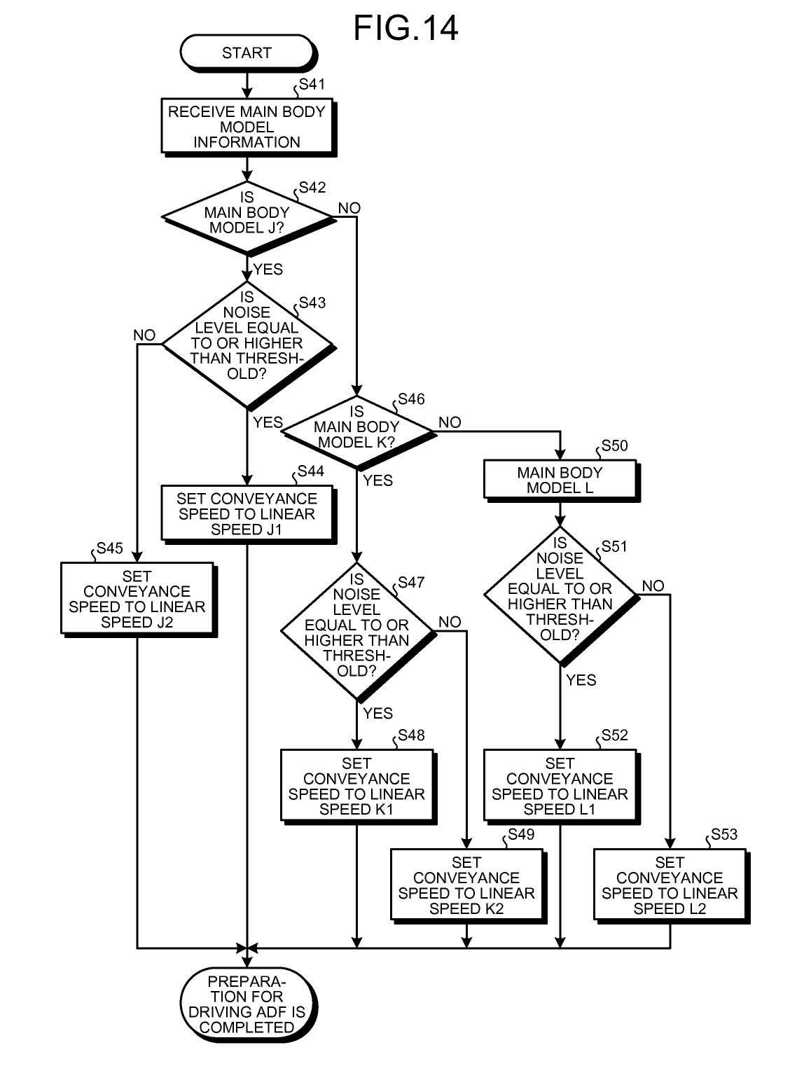

FIG. 14 illustrates another example of the processing of setting the conveyance speed of document sheets that the controller unit 100 according to the present embodiment executes.

In this conveyance speed setting processing, the conveyance speed of document sheets is set on the basis of noise in the surroundings of the image forming apparatus 1, which is, for example, a noise level inside a room in which the image forming apparatus 1 is installed. Specifically, when a noise level measured by a noise meter is equal to or higher than a threshold, the conveyance speed of document sheets is set to a linear speed for the productivity mode. On the other hand, when the noise level measured by the noise meter is lower than the threshold, the conveyance speed of document sheets is set to a linear speed for the silent mode, so that the quietness inside the room can be kept. Relations between respective modes and corresponding conveyance speeds with respect to each main body model are previously stored in the ROM in the controller unit 100 as in the above described example.

Exemplary methods for determining whether the noise level exceeds the threshold include: a method of measuring noise once every several seconds and comparing a measurement value immediately before the device starts operating with the threshold; and a method of comparing, with the threshold, the average of a plurality of measurement values before the device starts operating.

The controller unit 100 has the above-described main body models J, K, and L connected thereto. For the convenience of explanation, only one of the main body models J, K, and L is selectively powered on. The controller unit 100 detects whether a noise level measured by a noise meter is equal to or higher than a threshold.

As illustrated in FIG. 14, when only one of the main body models J, K, and L is selectively powered on, the controller unit 100 receives the main body model information from the main body model that has been turned on (Step S41).

Upon receiving the main body model information of the main body model J (Yes at Step S42), the controller unit 100 detects whether the noise level is equal to or higher than the threshold (Step S43).

If the noise level is equal to or higher than the threshold (Yes at Step S43), the controller unit 100 acquires information on the linear speed J1 from the main body controller of the main body model J and sets the conveyance speed of document sheets to the linear speed J1 for the productivity mode (Step S44), thereby completing preparation for driving the ADF.

If the noise level is lower than the threshold (No at Step S43), the controller unit 100 sets the conveyance speed of document sheets to the linear speed J2 for the silent mode (Step S45), thereby completing preparation for driving the ADF.

When not having received the main body model information of the main body model J (No at Step S42), upon receiving the main body model information of the main body model K (Yes at Step S46), the controller unit 100 detects whether the noise level is equal to or higher than the threshold (Step S47).

If the noise level is equal to or higher than the threshold (Yes at Step S47), the controller unit 100 sets the conveyance speed of document sheets to the linear speed K1 for the productivity mode (Step S48), thereby completing preparation for driving the ADF.

If the noise level is lower than the threshold (No at Step S47), the controller unit 100 sets the conveyance speed of document sheets to the linear speed K2 for the silent mode (Step S49), thereby completing preparation for driving the ADF.

When not having received the main body model information of the main body model K (No at Step S46), upon receiving the main body model information of the main body model L (Yes at Step S50), the controller unit 100 detects whether the noise level is equal to or higher than the threshold (Step S51).

If the noise level is equal to or higher than the threshold (Yes at Step S51), the controller unit 100 sets the conveyance speed of document sheets to the linear speed L1 for the productivity mode (Step S52), thereby completing preparation for driving the ADF.

If the noise level is lower than the threshold (No at Step S51), the controller unit 100 sets the conveyance speed of document sheets to the linear speed L2 for the silent mode (Step S53), thereby completing preparation for driving the ADF.

Thus, a conveyance speed for the productivity mode and a conveyance speed for the silent mode with respect to each main body model can be easily set in the controller unit 100 on the basis of a noise level inside a room by the application of the document sheet conveyance speed setting processing in FIG. 14 to the image forming apparatus 1 in which the automatic document feeding unit 5 has the main body models J, K, and L connected thereto.

The automatic document feeder, the image reading device, the image forming apparatus, and the image forming system according to the present invention are not limited to the above described embodiment. The automatic document feeder according to the present invention can also be applied to various image forming apparatuses and image forming systems.

The present invention enables provision of an automatic document feeder, an image forming apparatus, and an image forming system that can reduce noise without reducing productivity in printing in a silent mode.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An automatic document feeder comprising:
a first conveyance portion through which documents from a bundle of documents placed on a paper feeding tray are separated from one another and conveyed to a reading position;
a second conveyance portion through which a document having been conveyed to the reading position is ejected onto a paper ejection tray;
a detector that detects any one mode from a productivity mode and a silent mode; and
a controller that controls, when the detector has detected the productivity mode, the first conveyance portion so as to bring a conveyance speed in the first conveyance portion to a first conveyance speed, and, when the detector has detected the silent mode, controls the first conveyance portion so as to bring a conveyance speed in the first conveyance portion to a second conveyance speed that is slower than the first conveyance speed.

2. The automatic document feeder according to claim 1, wherein
the controller sets the silent mode as a default mode.

3. The automatic document feeder according to claim 1, wherein
the controller is configured to, when the detector has detected the productivity mode, control the second conveyance portion so as to bring a conveyance speed in the second conveyance portion to the first conveyance speed, and, when the detector has detected the silent mode, control the second conveyance portion so as to bring a conveyance speed in the second conveyance portion to the second conveyance speed.

4. The automatic document feeder according to claim 3, wherein,
on a conveyance route from the paper feeding tray to the paper ejection tray, the controller changes, from the first conveyance speed to the second conveyance speed and vice versa, each of the conveyance speeds in the first conveyance portion and the second conveyance portion in sections other than sections in each of which the documents are present at least at the reading position.

5. The automatic document feeder according to claim 3, wherein
the controller changes, from the first conveyance speed to the second conveyance speed and vice versa, a conveyance speed of each roller other than rollers that are nipping the documents at the reading position.

6. An image reading device comprising the automatic document feeder according to claim 1.

7. An image forming apparatus comprising:
the automatic document feeder according to claim 1; and
an apparatus main body having a copy function, wherein
the detector acquires, from a main body controller of the apparatus main body, information on whether the automatic document feeder is in the productivity mode or in the silent mode.

8. The image forming apparatus according to claim 7, wherein
the main body controller performs control that causes a display unit of the apparatus main body to display which of the productivity mode and the silent mode the automatic document feeder is in.

9. An image forming apparatus comprising:
the automatic document feeder according to claim 1; and
an apparatus main body having a copy function, wherein
the automatic document feeder comprises a receiving unit that receives model information on the apparatus main body, and
the controller controls at least one of the first conveyance speed and the second conveyance speed so as to bring the at least one of the first conveyance speed and the second conveyance speed to a conveyance speed or conveyance speeds previously set in accordance with the model information received by the receiving unit.

10. An image forming system comprising:
the image forming apparatus according to claim 7; and
a finisher that performs a post-process on recording paper on which image fixing has been completed.

11. An image forming system comprising:
the image forming apparatus according to claim 9; and
a finisher that performs a post-process on recording paper on which image fixing has been completed.
